(19) United States
(12) Patent Application Publication
(10) Pub. No.: US 2026/0151864 A1
(43) Pub. Date: Jun. 4, 2026

(54) METHOD FOR MANUFACTURING GOLF CLUB HEAD

(71) Applicant: Sumitomo Rubber Industries, Ltd., Hyogo (JP)

(72) Inventor: Yuki SHIMAHARA, Kobe-shi (JP)

(73) Assignee: Sumitomo Rubber Industries, Ltd., Hyogo (JP)

(21) Appl. No.: 19/379,129

(22) Filed: Nov. 4, 2025

(30) Foreign Application Priority Data
Dec. 2, 2024 (JP) 2024-209778

(51) Int. Cl. B23P 15/00; A63B 53/04; B23P 25/00

(52) U.S. Cl. CPC B23P 15/00; A63B 53/0445; B23P 25/00

(57) ABSTRACT

A method for manufacturing a golf club head comprises a step of preparing a head main body having a plane forming a ball striking face; a step of forming, in the plane, a primary groove having a groove depth exceeding the upper limit depth specified by the Rules of Golf; and a step of surface-trimming the plane to obtain a secondary groove having a groove depth complying with the Rules of Golf while maintaining the shape of the groove bottom of the primary groove, wherein the surface treatment is a blasting treatment in which abrasive materials are collided against the plane.

### TECHNICAL FIELD

The present disclosure relates to a method for manufacturing a golf club head.

### BACKGROUND ART

Patent Document 1 listed below discloses a method for manufacturing a golf club head in which grooves are formed in the ball striking face.

Patent Document 1: Japanese Patent Application Publication No. 2018-134377A

### SUMMARY OF THE INVENTION

### Problems to Be Solved by the Invention

For the grooves formed in the striking face, from the standpoint of the bite of the striking face on the ball, and the effect of cutting off the turfs or grass interposed between the striking face and the ball, it is desirable to have sharper groove shoulders/edges and larger groove volume within the ranges specified by the Rules of Golf.

Generally, in a method for forming grooves by the use of a cutting tool, forming die or the like, there is a trade-off between sharp groove shoulders/edges and groove volume.

Namely, when the grooves are formed, if the groove depth deviates from the target depth and becomes greater, then the groove volume will become too large. Conversely, if the groove depth deviates from the target depth and becomes smaller, the groove shoulders/edges will become too sharp. In either case, the problem arises such that the grooves no longer comply with the Rules of Golf.

In view of the above-described circumstances, the present disclosure was devised, and a primary objective of the present disclosure is to provide a method for manufacturing a golf club head, by which a golf club head can be provided with grooves achieving sharper groove shoulders and larger groove volume which can satisfy the Rules of Golf without fail.

### Means for Solving the Problems

According to the present disclosure, a method for manufacturing a golf club head comprises:
a preparation step of preparing a head main body having a plane forming a striking face for striking the ball;
a formation step of forming, in the plane, at least one primary groove extending in a toe-heel direction, and having a groove depth larger than the upper limit depth specified by the Rules of Golf; and
a surface trimming step for surface-trimming the plane to reduce the groove depth of the primary groove while maintaining the shape of at least the bottom of the primary groove so as to obtain the primary groove as a secondary groove having a groove depth complying with the Rules of Golf, wherein the surface-trimming is a blasting treatment process in which abrasive materials are collided against the plane, whereby the striking face with a groove is formed by the surface-trimmed plane with the secondary groove.

### Effects of the Invention

In the method for manufacturing a golf club head according to the present disclosure, by having the above-described steps, it is possible to manufacture a golf club head having grooves which achieve sharper groove shoulders and larger groove volume within the Rules of Golf.

### BRIEF DESCRIPTION OF THE DRAWINGS

FIG. 1 is a front view of a golf club head as an embodiment of the present disclosure.

FIG. 2 is a cross-sectional view of the golf club head taken along line A-A in FIG. 1.

FIG. 3 is a flowchart showing the steps of a method for manufacturing the golf club head.

FIG. 4 is a diagram for explaining the formation step S2.

FIG. 5 is an enlarged view of the tip of an edged tool used in the formation step S2.

FIG. 6 is an enlarged cross-sectional view of the tip of the edged tool.

FIG. 7 is a cross-sectional view of the primary groove.

FIG. 8 is a cross-sectional view showing a state in the middle of the formation step in which the primary groove is formed halfway.

FIG. 9 is a diagram for explaining the covering step S3 and the surface trimming step S4.

FIG. 10 is a diagram for explaining the formation step S2 of another embodiment.

### DETAILED DESCRIPTION OF THE INVENTION

Embodiment of the present disclosure will now be described in detail in conjunction with the accompanying drawings.

The drawings may contain exaggerations and dimensional ratios different from the actual ratios in order to aid the understanding of the present disclosure. For the different embodiments, the same reference numerals are assigned to the same or common parts, and duplicate explanations are omitted.

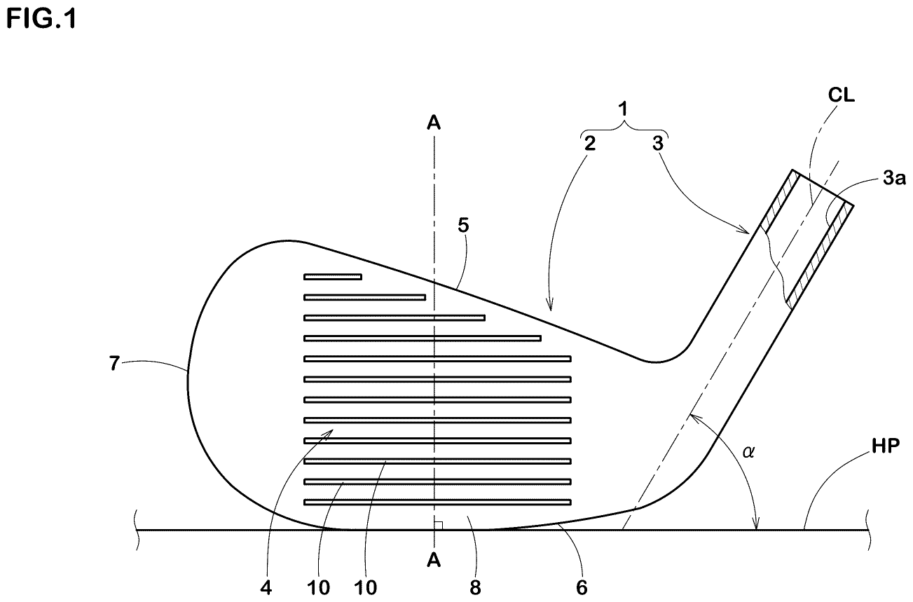

FIG. 1 is a front view of a golf club head 1 (hereinafter sometimes simply referred to as the head 1) manufactured by a manufacturing method as an embodiment of the present disclosure, wherein the head 1 is under its a reference state.

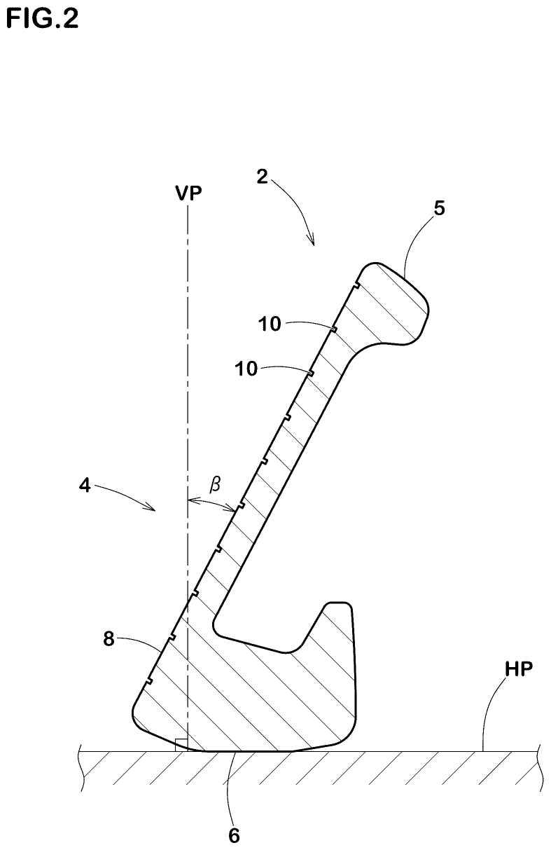

FIG. 2 is a cross-sectional view taken along line A-A of FIG. 1.
As shown in FIGS. 1 and 2, the head 1 includes a head main body 2 and a hosel portion 3.

The head main body 2 is provided with a striking face 4 for striking the ball. The head main body 2 in this example further includes, a top 5, a sole 6 and a toe 7.

The striking face 4 is provided with at least one groove 10 extending in the toe-heel direction of the head. In the present embodiment, a plurality of parallel grooves 10 are provided.

The striking face 4 in this example is formed by a plane 8 in which the grooves 10 are to be formed.
The plane 8 is substantially flat if the irregularities caused by the blasting treatment process described below are not provided.

In addition, the striking face 4 may be provided with an auxiliary groove (not shown). The auxiliary groove is a groove having a smaller groove depth and a smaller width as compared with those of the groove 10.

For example, the auxiliary groove has a groove depth of 0.005 to 0.025 mm, and a groove width of 0.10 to 0.50 mm, and a pair of opposite groove walls of the auxiliary groove are inclined at an angle of 40 to 70 degrees so that the width therebetween increases toward the groove opening.
Thus, the auxiliary groove is clearly distinguished from the groove 10.

The top 5 is an upper surface portion of the head 1 extending from the upper edge of the striking face 4 toward the rear side of the head.

The sole 6 is a bottom surface portion of the head 1 extending from the lower edge of the striking face 4 toward the rear side of the head.

The toe 7 is a portion which is furthest from the hosel portion 3 and smoothly connects the top 5 and the sole 6.

The hosel portion 3 is provided with a shaft insertion hole 3a into which the tip end of a club shaft (not shown) is inserted and fixed.

The hosel portion 3 in this example is formed in a cylindrical shape.

The shape of the head 1 is not limited to that illustrated in the drawings, and various shapes may be adopted.

In the present embodiment, the head 1 is formed as an iron-type head for an iron club although the head 1 may be formed as a wood-type head, a utility-type head, or a putter-type head.

The head 1 in this example is entirely made of a metal material.
As the metal material, for example, carbon steel, stainless steel, titanium alloy, maraging steel and the like can be preferably used.
Further, it may be possible to form the head 1 from one type of metal material, or a combination of two or more types of metal materials.

The above-mentioned “reference state” of a golf club head is a state in which the head is set on a horizontal plane HP; the shaft center line CL of the head lies within a vertical plane VP (shown in FIG. 2) orthogonal to the horizontal plane HP; the angle between the shaft center line CL and the horizontal plane HP is set to a lie angle α (shown in FIG. 2) specified for the head; and the angle of the striking face 4 with respect to the vertical plane VP is set to a loft angle β (shown in FIG. 1) specified for the head.

The shaft center line CL corresponds to the center line of the shaft insertion hole 3a formed in the hosel portion 3.

In this application including the specification and claims, unless otherwise noted, descriptions of the golf club head are made based on the head being under its reference state.

In the case of the head 1 provided with the grooves 10 as in the present embodiment, each of the grooves 10 is parallel to the horizontal plane HP in the reference state.

Three orthogonal directions of a golf club head are defined in relation to the reference state as follows: the toe-heel direction of the head is a direction parallel to the vertical plane VP and the horizontal plane HP; the front-back direction of the head is a direction perpendicular to the vertical plane VP; and the up-down direction of the head is a direction perpendicular to the horizontal plane HP.

Next, a method for manufacturing a golf club head according to the present disclosure will be described.

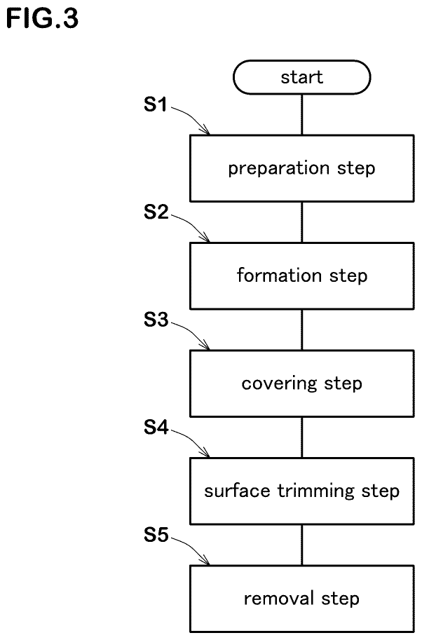

FIG. 3 shows a flowchart of a method for manufacturing the golf club head 1 as an embodiment of the present disclosure (hereinafter, sometimes referred as the manufacturing method).

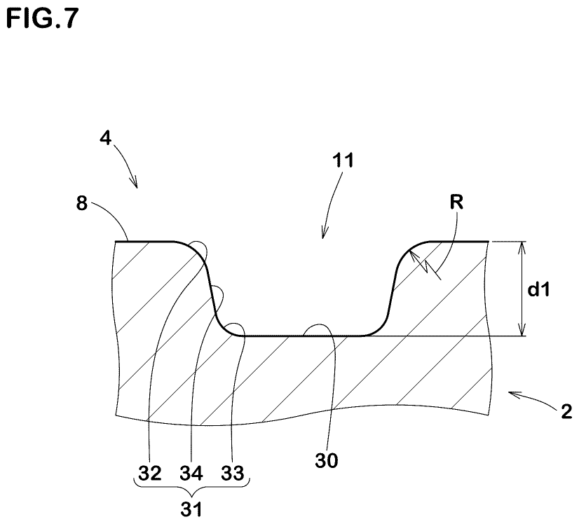

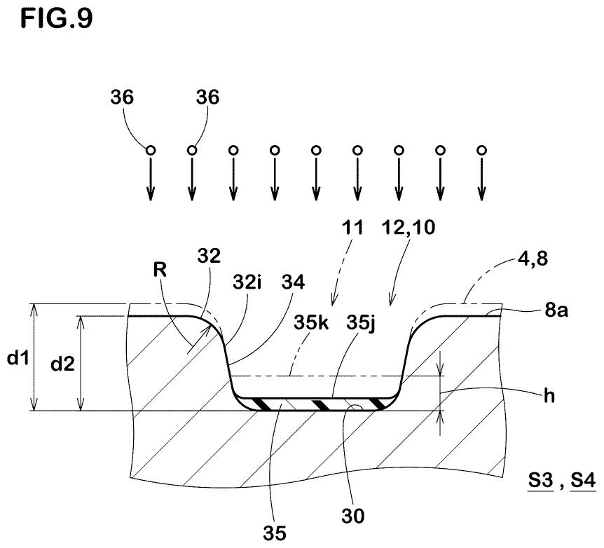

As shown in FIG. 3, the manufacturing method in the present embodiment comprises:
a preparation step S1 of preparing the head main body 2;
a formation step S2 of forming the after-described primary groove 11 (shown in FIG. 7);
a covering step S3 of placing a covering material 35 (shown in FIG. 9) in the primary groove 11;
a surface trimming step S4 for obtaining the after-described secondary groove 12 (shown in FIG. 9); and
a removal step S5 of removing the covering material 35.

In the present embodiment, the preparation step S1 is firstly carried out.

In the preparation step S1, the head main body 2 is prepared.
In this step, the striking face 4 of the head main body 2 is not yet provided with the groove or grooves 10.
The striking face 4 prepared in the preparation step S1 may be provided with a marking indicating the formation position of the groove 10.
To be precise, the striking face 4 in this step is a flat plane 8 before it is processed into the striking face 4.

Next, the formation step S2 is carried out.

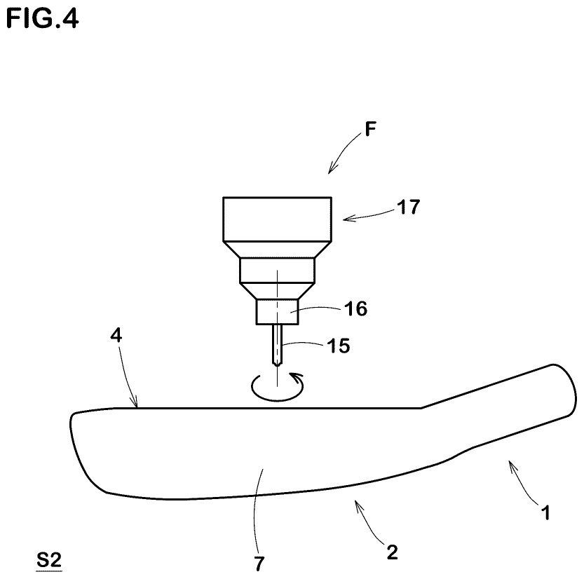

FIG. 4 is a diagram for explaining the formation step S2.
In the formation step S2, a primary groove 11 (shown in FIG. 7) is formed in the plane 8 by cutting in the present embodiment.
For example, by the use of a NC (numeric control) processing machine F such as machining center and milling machine, the primary groove 11 is formed.

The NC processing machine F is equipped with an edged tool 15 for engraving the primary groove 11, a support 16 rotatably supporting the edged tool 15, and a moving device 17 for moving the support 16.

Preferably, the edged tool 15 is a cutting tool such as an end mill.
The edged tool 15 is rotated around a central axis c1.
The moving tool 17 is for moving the edged tool 15 in the toe-heel direction, the front-back direction and the up-down direction of the head 1.
In the formation step S2 of the present embodiment, the head main body 2 is held by a holder (not shown) in the NC processing machine F.
The NC processing machine F forms the primary groove 11 by moving the edged tool 15 in a predetermined direction in accordance with programming.

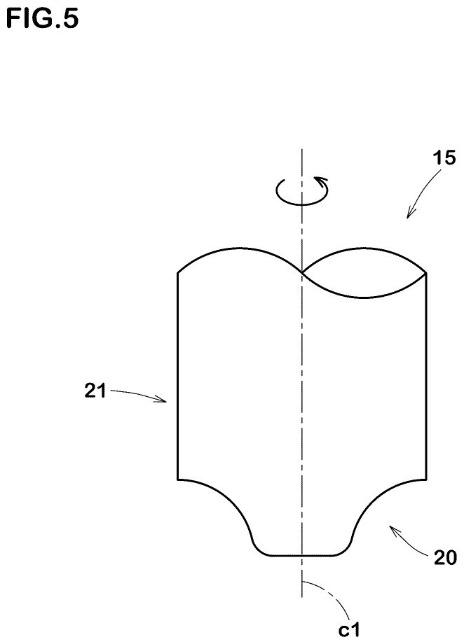

FIG. 5 is an enlarged view of the tip of the edged tool 15.

As shown in FIG. 5, the edged tool 15 in this embodiment has a base body 21 and a cutting surface 20.
The base body 21 is cylindrical. The base body 21 is supported by the support 16.

The plane 8 forming the striking face 4 is cut by at least a portion of the cutting surface 20 coming into contact with the plane 8.

In this specification, unless otherwise specified, the “cross section” of the edged tool 15 means a cross section passing through the central axis c1 and parallel to the central axis c1.

In addition, in this specification, the “cross section” of the groove 10 (including primary groove 11 and secondary groove 12) means a cross section perpendicular to the plane 8 and perpendicular to the longitudinal direction of the groove 10.

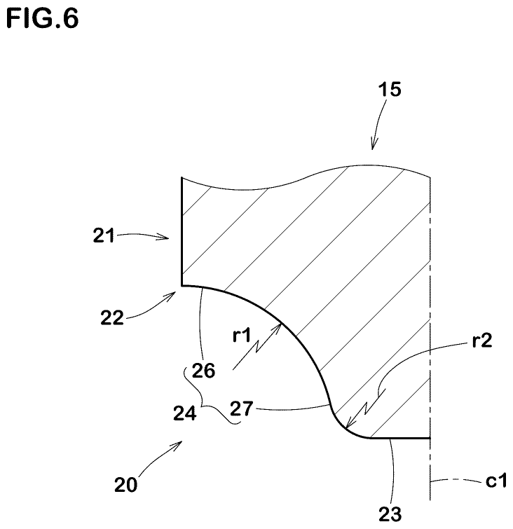

FIG. 6 is an enlarged cross-sectional partial view of the tip of the edged tool 15 showing one half on one side (left side) of the central axis c1. The entire cross section of the edged tool 15 is symmetrical about the central axis c1.

As shown in FIG. 6, the cutting surface 20 includes a top surface 23 and a side surface 24.

The side surface 24 is located between the outer peripheral surface of the base body 21 and the top surface 23.
The side surface 24 has a first arcuate portion 26 and a second arcuate portion 27.

In the edged tool 15 of the present embodiment, the top surface 23 is a flat surface, more specifically, a circular flat surface. The top surface 23 is perpendicular to the central axis c1.

But, the top surface 23 is not limited to such a flat surface. It may be a curved surface or an uneven surface. Further, the top surface 23 may be not perpendicular to the central axis c1.

The first arcuate portion 26 has an arc shape in the cross section, and the arc shape is concave in the centripetal direction to the central axis c1.

The first arcuate portion 26 is connected to the outer peripheral surface of the base body 21.
As shown in the cross section, a sharp protruding corner 22 is formed between the first arcuate portion 26 and the outer peripheral surface of the base body 21.

The second arcuate portion 27 has an arc shape in the cross section, and the arc shape is convex in the centrifugal direction to the central axis c1.

The second arcuate portion 27 is smoothly continuous with the first arcuate portion 26.

In the cross section of the edged tool 15, the first arcuate portion 26 has a radius of curvature r1, the second arcuate portion 27 has a radius of curvature r2, and the radius of curvature r1 is larger than the radius of curvature r2.

FIG. 7 is an enlarged cross-sectional view of the primary groove 11 formed by the edged tool 15 of the present embodiment.

As shown in FIG. 7, the primary groove 11 has
a groove bottom 30 formed by cutting using the top surface 23, and
groove wall portion 31 on each side formed by cutting using the side surface 24.

The groove wall portion 31 includes
a groove shoulder portion 32 formed by the first arcuate portion 26,
a rising portion 33 formed by the second arcuate portion 27, and
a groove wall portion 34 connecting between the rising portion 33 and the groove shoulder portion 32.

In this example, the rising portion 33 is smoothly continuous with the groove bottom 30. The rising portion 33 is formed as a concave curved surface.

In this example, the groove shoulder portion 32 connects the striking face 4 (plane 8) and the groove wall portion 34.
In this example, the groove shoulder portion 32 is smoothly continuous with the plane 8.
In this example, the groove shoulder portion 32 smoothly merges with the groove wall portion 34.
In this example, the groove shoulder portion 32 is formed as a convex curved surface.
In this example, the groove wall portion 34 extends linearly in the cross section.

In the cross section of the primary groove 11, the radius of curvature R of the groove shoulder portion 32 is set to a value which complies with the Rules of Golf.

The groove depth d1 of the primary groove 11 formed in the formation step S2 is set to a value larger than the upper limit value set forth in the Rules of Golf.

In this specification, the Rules of Golf refer to the “Rules of Golf” established by the USGA/R&A.

The primary groove 11 is not limited to this form, and may have various shapes as long as the form complies with the Rules of Golf except that the groove depth d1 is set to a value exceeding the upper limit value of the Rules of Golf.

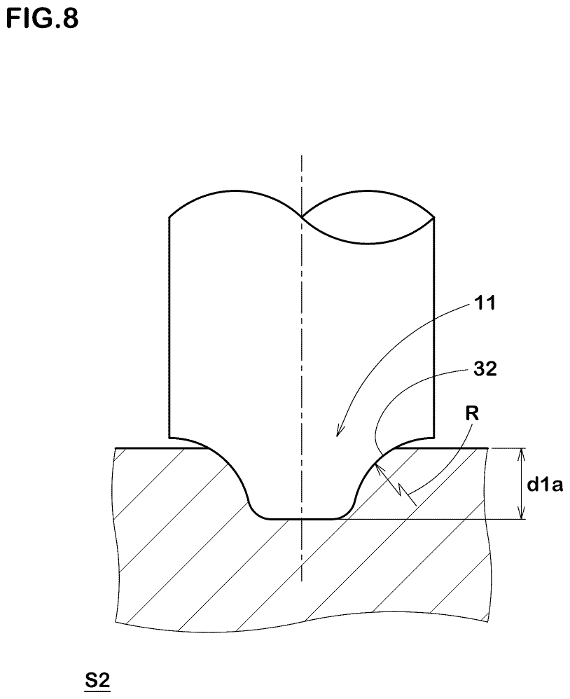

FIG. 8 is a cross-sectional view showing a state in the middle of the formation step S2.

When the primary groove 11 is in the middle of the formation step S2, as shown in FIG. 8, the groove depth d1a of the primary groove 11 may comply with the Rules of Golf even though the curvature radius R of the groove shoulder portion 32 does not comply with the Rules of Golf.
However, in the formation step S2 of the present embodiment, the radius of curvature R of the groove shoulder portion 32 increases as the groove depth d1a of the primary groove 11 increases with the progress of the formation step S2.

Next, the covering step S3 is carried out.

FIG. 9 is a diagram for explaining the covering step S3 and the surface trimming step S4.
In FIG. 9, the cross section of the primary groove 11 before and after the surface trimming step S4 is shown. In FIG. 9, the state after the surface trimming step S4 is indicated by a solid line, and positions changed by the surface trimming step S4 are indicated by a two-dot chain line.

In the covering step S3 of the present embodiment, as shown in FIG. 9, a covering material 35 is placed in the primary groove 11 to cover the groove bottom 30.

The covering material 35 is preferably a hardened resin or paint.
The resin may be, for example, a synthetic resin such as a thermoplastic resin or a thermosetting resin. In particular, Fluorresin is preferably used as the resin.
The hardened paint refers to a paint that has hardened with time.
The paint may be a water-based paint, an oil-based paint or a spray paint.
In particular, as the hardened paint, urethane, rubber, etc. are suitable.

Such covering material 35 can prevent the groove bottom 30 from being abraded while allowing the plane 8 to be abraded when the next surface trimming step S4 is carried out, so the groove depth d1 of the primary groove 11 can be made smaller by the surface trimming step S4.

From the standpoint of maintaining the above-described contour shape of the groove bottom 30 of the primary groove 11, it is preferable that the thickness h of the covering material 35 in the groove depth direction is not less than 10% of the groove depth d1 of the primary groove 11.

In addition, from the viewpoint of maintaining the radius of curvature R of the groove shoulder portion 32 after the surface trimming step S4 within a range that complies with the Rules of Golf, it is preferable that the covering material 35 is disposed at least on the groove bottom 30 side of the inner end 32i of the groove shoulder portion 32. The inner end 32i corresponds to the boundary between the groove shoulder portion 32 and the groove wall portion 34.

Next, the surface trimming step S4 is carried out.

The surface trimming step S4 is for trimming the surface of the plane 8 (striking face 4).
In the surface trimming step S4 in the present embodiment, a blasting treatment process in which abrasive materials 36 are collided with the striking face 4 at high speeds is carried out.
The blasting treatment process can chip away the surface of the plane 8.
In FIG. 9, the plane 8 (two-dot chain line) after the blasting treatment process is indicated by reference numeral 8a (solid line).

Since the covering material 35 is placed on the groove bottom 30 in the covering step S3, the groove bottom 30 does not chip away by the blasting.

Therefore, in the surface trimming step S4, the groove depth d1 of the primary groove 11 is reduced. As a result, the primary groove 11 can be obtained as a secondary groove 12 having a groove depth d2 that complies with the Rules of Golf.

In the blasting treatment process, the abrasive materials 36 are jetted at an angle close to the normal direction to the plane 8.

Such blasting treatment can apply to the entire groove shoulder portion 32.
Therefore, the blasting treatment can chip away the plane 8, the portion of the groove shoulder portion 32 close to the plane 8, and the portion of the groove shoulder portion 32 close to the groove wall portion 34.
Such blasting can maintain the radius of curvature R of the groove shoulder portion 32 within a range that complies with the Rules of Golf, as compared with milling.
Accordingly, in the manufacturing method in the present embodiment, it is possible to manufacture the golf club head 1 having the grooves 10 (secondary groove 12) achieving sharper groove shoulder portions 32 and a larger groove volume within the Rules of Golf.
In FIG. 9, a surface 35k of the covering material 35 before the surface trimming step S4 is indicated by a two-dot chain line, and a surface 35j of the covering material 35 after the surface trimming step S4 is indicated by a solid line.

The blasting treatment is not particularly limited, but well-known blasting treatments such as sand blasting, shot peening, or grit blasting can be employed.

The difference (d1−d2) between the groove depth d1 of the primary groove 11 and the groove depth d2 of the secondary groove 12 is not particularly limited, but, preferably not less than 0.01 mm, more preferably not less than 0.02 mm, and preferably not more than 0.05 mm, more preferably not more than 0.04 mm.

The difference (d1−d2) corresponds to the thickness of the surface layer of the plane 8 which is removed by the surface trimming step S4.
The secondary groove 12 is equal to the groove 10 provided in the striking face 4.

Next, the removal step S5 is carried out.

In the removal step S5 of the present embodiment, any known method suitable for removing the covering material 35 can be carried out. For example, a method of applying a solvent capable of dissolving the covering material 35 can be employed.

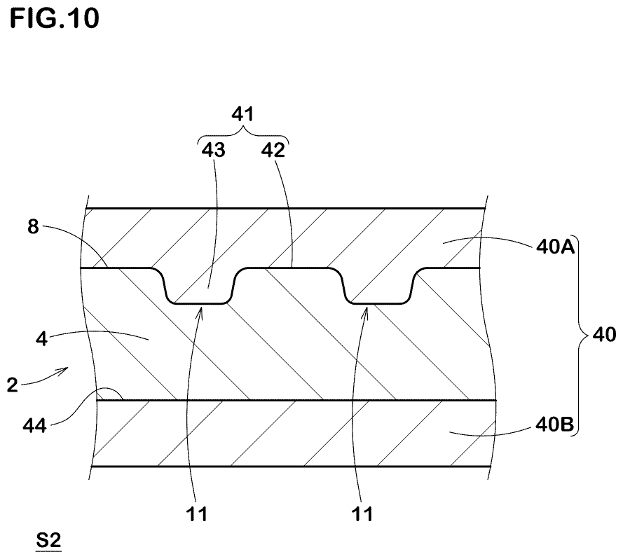

FIG. 10 is a diagram for explaining the formation step S2 in another embodiment.

In FIG. 10, the cross section of the primary groove 11 is shown.
In the formation step S2 of this embodiment, a press process is carried out in which a die 40 is pressed against the plane 8 as shown in FIG. 10.
The die 40 includes an upper die 40A and a lower die 40B which holds the head main body 2.

The upper die 40A in this example has a shaping surface 41 which comprises a main surface 42 formed by a flat surface, and a plurality of small protrusions 43 protruding from the main surface 42 and having inverted shapes of the respective primary grooves 11.

The lower die 40B in this example has a support surface 44 for holding the rear side of the striking face 4.
By pressing the shaping surface 41 of the upper die 40A against the plane 8 (face 4) of the head main body 2 held by the lower die 40B, the primary grooves 11 are formed as the formation step S2. Other steps can be applied as explained above.

While detailed description has been made of preferable embodiments of the present disclosure, the present disclosure can be embodied in various forms without being limited to the illustrated embodiments.

### Statement of the Present Disclosure

The present disclosure is as follows.

### Present Disclosure 1

A method for manufacturing a golf club head, comprises:
a preparation step of preparing a head main body having a plane forming a striking face for striking the ball;
a formation step of forming, in the plane, at least one primary groove extending in a toe-heel direction, and having a groove depth larger than the upper limit depth specified by the Rules of Golf; and
a surface trimming step of surface-trimming the plane to reduce the groove depth of the primary groove while maintaining the shape of at least the bottom of the primary groove so as to obtain the primary groove as a secondary groove having a groove depth complying with the Rules of Golf, wherein the surface-trimming is a blasting treatment process in which abrasive materials are collided against the plane, whereby the striking face with a groove is formed by the surface-trimmed plane with the secondary groove.

### Present Disclosure 2

The method for manufacturing a golf club head according to Present Disclosure 1, wherein the formation step is carried out using a cutting tool or die such that the radius of curvature of a groove shoulder portion of the at least one primary groove between the striking face and each groove wall of the at least one primary groove increases as the groove depth increases.

### Present Disclosure 3

The method for manufacturing a golf club head according to Present Disclosure 1 or 2, which further comprises a covering step of placing a covering material in the primary groove, prior to the blasting treatment, to protect the bottom of the at least one primary groove.

### Present Disclosure 4

The method for manufacturing a golf club head according to Present Disclosure 3, wherein the covering material is a resin.

### Present Disclosure 5

The method for manufacturing a golf club head according to Present Disclosure 3, wherein the covering material is a hardened paint.

### Present Disclosure 6

The method for manufacturing a golf club head according to any one of Present Disclosures 3 to 5, wherein the thickness of the covering material in the groove depth direction is not less than 10% of the groove depth of the primary groove.

### present Disclosure 7

The method for manufacturing a golf club head according to any one of Present Disclosures 3 to 6, which further comprises a removal step of removing the covering material after the blasting treatment process.

### DESCRIPTION OF THE REFERENCE SIGNS

1 golf club head
2 head main body
4 striking face
11 primary groove
12 secondary groove
30 groove bottom
36 abrasive material
d2 groove depth
d1 groove depth

1. A method for manufacturing a golf club head, comprising:
a preparation step of preparing a head main body having a plane forming a striking face for striking the ball;
a formation step of forming, in the plane, at least one primary groove extending in a toe-heel direction, and having a groove depth larger than the upper limit depth specified by the Rules of Golf; and
a surface trimming step of surface-trimming the plane to reduce the groove depth of the primary groove while maintaining the shape of at least the bottom of the primary groove so as to obtain the primary groove as a secondary groove having a groove depth complying with the Rules of Golf, wherein the surface-trimming is a blasting treatment process in which abrasive materials are collided against the plane, whereby the striking face with a groove is formed by the surface-trimmed plane with the secondary groove.

2. The method for manufacturing a golf club head according to claim 1, wherein the formation step is carried out using a cutting tool or die such that the radius of curvature of a groove shoulder portion of the at least one primary groove between the striking face and each groove wall of the at least one primary groove increases as the groove depth increases.

3. The method for manufacturing a golf club head according to claim 1, which further comprises a covering step of placing a covering material in the primary groove, prior to the blasting treatment, to protect the bottom of the at least one primary groove.

4. The method for manufacturing a golf club head according to claim 2, which further comprises a covering step of placing a covering material in the primary groove, prior to the blasting treatment, to protect the bottom of the at least one primary groove.

5. The method for manufacturing a golf club head according to claim 3, wherein the covering material is a resin.

6. The method for manufacturing a golf club head according to claim 4, wherein the covering material is a resin.

7. The method for manufacturing a golf club head according to claim 3, wherein the covering material is a hardened paint.

8. The method for manufacturing a golf club head according to claim 4, wherein the covering material is a hardened paint.

9. The method for manufacturing a golf club head according to claim 3, wherein the thickness of the covering material in the groove depth direction is not less than 10% of the groove depth of the primary groove.

10. The method for manufacturing a golf club head according to claim 5, wherein the thickness of the covering material in the groove depth direction is not less than 10% of the groove depth of the primary groove.

11. The method for manufacturing a golf club head according to claim 7, wherein the thickness of the covering material in the groove depth direction is not less than 10% of the groove depth of the primary groove.

12. The method for manufacturing a golf club head according to claim 3, which further comprises a removal step of removing the covering material after the blasting treatment process.

13. The method for manufacturing a golf club head according to claim 5, which further comprises a removal step of removing the covering material after the blasting treatment process.

14. The method for manufacturing a golf club head according to claim 7, which further comprises a removal step of removing the covering material after the blasting treatment process.

15. The method for manufacturing a golf club head according to claim 9, which further comprises a removal step of removing the covering material after the blasting treatment process.
